(19) United States
(12) Patent Application Publication
(10) Pub. No.: US 2003/0000862 A1
(43) Pub. Date: Jan. 2, 2003

(54) Container with windowed label

(76) Inventor: Martin Matushek, West Dundee, IL (US)

Correspondence Address: Matthew E. Leno, McDermott, Will & Emery, 31st Floor, 227 West Monroe Street, Chicago, IL, 60606, US

(21) Appl. No.: 09/882,010

(22) Filed: Jun. 15, 2001

(51) Int. Cl. B65D 85/00; G09F 3/00; B42D 15/00

(52) U.S. Cl. 206/459.5; 40/310; 283/81; 206/782

(57) ABSTRACT

A container label defining one or more windows to be associated with one or more windows of a container on which the label is intended to be affixed. The one or more label windows provide a prospective customer with greater visibility of the product within the container and eliminate the possibility of damage to the label portion that would otherwise cover the container windows.

### BACKGROUND OF THE INVENTION

1. Field of the Invention

The present invention relates generally to a labeled container; particularly to a windowed label for use with a container comprising window panel such that the label window is registered with the container window.

2. Background

Labels have long been employed on containers used to deliver a product from a manufacturer to a customer. Labels were used to provide the customer with data about the product within the container or the manufacturer of the product. Labels were also used as a marketing tool for attracting customer attention to the product while it rested on a store shelf. Additionally, the label was often employed as a promotional medium such as by providing coupons. When required, labels were also used to impart other information about the product as required by prevailing government regulations.

Allowing a prospective customer to view the product itself has also long been considered an effective marketing tool. This has been accomplished, for instance, by constructing the product container to be clear or translucent. However, labels configured to accommodate all of the required data and desired marketing information have often been large enough to cover a majority of the container to which it is configured to be attached. Thus, while the customer was exposed to the information and messages of the label, the visibility of the product was significantly obstructed. The labels therefore detracted from the presentation of the product to prospective customers.

On particular container configurations, labels have also detracted from product presentation in other ways as well. One such container configuration was rigid, or semi-rigid, containers for hot-filled food products such as those made of polymers. The hot-filling process of packaging food products entails elevating the product temperature to a level at which all undesirable organisms will perish, placing the food product within the container, sealing the container while at the elevated temperature and allowing the container and food product to cool to ambient temperature. This process insures a sterilized food product. However, the food product, an any air in the sealed container, shrank during cooling and created a substantial internal vacuum. Rigid and semi-rigid hot-fill containers were, therefore, typically provided with structural features designed to allow the container to withstand this vacuum without substantial deformation. By way of example only, long, flat sidewalls of hot-fill bottles were the most susceptible to indentation due to internal vacuum as will be recognized by one of ordinary skill in the art. The sidewalls of hot-fill bottles were, therefore, often provided with ribs extending annularly about its circumference or strategically located indentations referred to as “windows,” “panels” or “vacuum panels” which added to the structural rigidity of the sidewall to limit the indentation caused by the vacuum.

Portions of a label placed over the vacuum panels would typically become damaged by the time it reached the store shelves to be viewed by the prospective customer. Damage resulted from the label being depressed into the recess of the vacuum panel. The label could become wrinkled or even punctured from normal handling of the container that was required to get it from the manufacturer to the store shelves. Labels in this wrinkled or punctured state detracted from the desired presentation of the product reducing the effectiveness of the label as a marketing tool.

### SUMMARY OF THE INVENTION

The present invention provides a container label defining one or more windows therein to be associated with one or more windows of a container on which the label is intended to be affixed. The one or more label windows can provide a prospective customer with greater visibility of the product within the container. The one or more label windows can also eliminate the possibility of damage to the label portion that would otherwise cover the container windows.

One objective of the present invention is to provide a labeled container facilitating visibility of the product within the container.

Another objective of the present invention is to provide a labeled container to limit potential damage to the label.

It is a further objective of the present invention to provide a windowed label for a container to facilitate visibility of the product within the container.

It is still another objective of the present invention to provide a windowed label for a windowed container to facilitate association of one or more label windows with one or more container windows to limit potential damage to the label.

Yet another object of the present invention is to provide a container having one or more windows and a label having one or more windows associated with the container windows.

### BRIEF DESCRIPTION OF THE DRAWINGS

FIG. 1 is an elevational view of one embodiment of a label susceptible of use with the present invention.

FIG. 2 is a perspective view of one embodiment of a container susceptible of use with the present invention.

FIG. 3A is a perspective view of the label of FIG. 1 positioned on the container of FIG. 2.

FIG. 3B is an elevational view of the label-container combination of FIG. 3A.

FIG. 4A is an elevational view depicting the container of FIG. 2 with another embodiment of the label of the present invention.

FIG. 4B is an elevational view depicting the container of FIG. 2 with yet another embodiment of the label of the present invention.

### DETAILED DESCRIPTION OF THE INVENTION

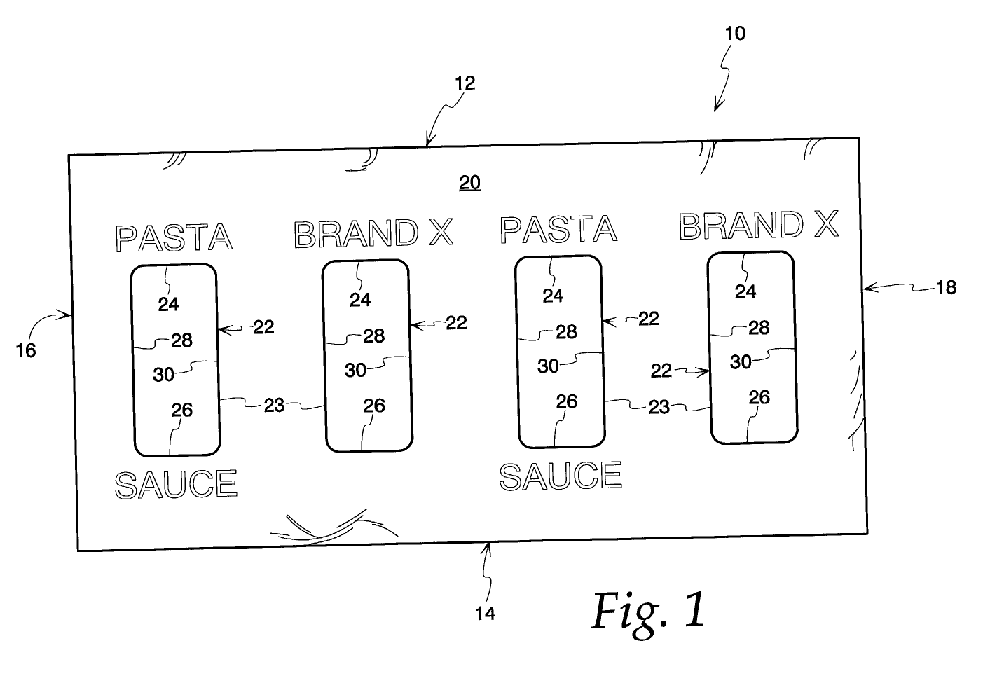

One embodiment of the label of the present invention is depicted as label 10 in FIG. 1. The label 10 has an upper edge 12, a lower edge 14, a left edge 16 and a right edge 18 defining a body 20 of the label 10. The label body 20 defines one or more apertures 22 referred to herein as “windows.” In the embodiment depicted in FIG. 1, the label body 20 comprises four windows 22. However, the present invention contemplates that the label body 20 may have any number of windows 22 regardless of the configuration of the container with which it will be associated, as discussed in more detail below. In the embodiment depicted in FIG. 1, each window 22 is of like shape and size defining a perimeter 23 comprising an upper edge 24, a lower edge 26, a left edge 28 and a right edge 30. It is not necessary, however, that each label window 22 be of like shape or size when the label body 20 comprised multiple windows.

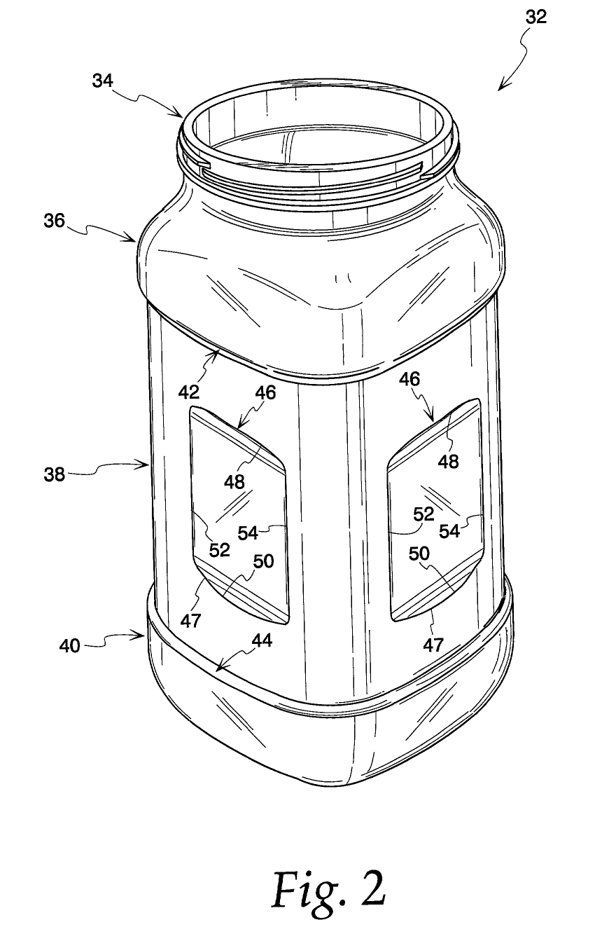

FIG. 2 depicts one embodiment of the container of the present invention as container 32. The depicted container 32 comprises a finish 34, a rounded shoulder 36, a label panel 38 and a base 40. An upper bevel 42 and a lower bevel 44 connect the label panel 38 to the rounded shoulder 36 and the base 40 respectively. The bevels 42, 44 recess the label panel 38 from the rounded shoulder 36 and the base 40, respectively, to protect the label panel 38, and any label placed thereon, from contacting an adjacent container of like configuration when located side-by-side such as when boxed for shipping. The container 32 comprises four sides of like configuration and forms a rounded square. Each side of the container comprises a vacuum panel 46 in the label panel area 38. The vacuum panels 46 may be referred to herein as “windows. ” The present invention contemplates containers have any number of sides of like configuration or a cylindrical configuration. Moreover, the present invention contemplates a container having less vacuum panels than sides so that some container sides comprise a vacuum panel while one or more others do not. Multiple vacuum panels on a side are also contemplated. The container windows 46 of the embodiment depicted in FIG. 2 define a container window perimeter 47 comprising and upper edge 48, a lower edge 50, a left edge 52 and a right edge 54. The container windows 46 recess from the label panel area 38 of the container 32. Other configurations of the container windows 46 are contemplated and the windows may differ in configuration one from the others without departing from the scope of the present invention. The container 32 may be constructed from any material including, but not limited to, glass, polypropylene, polyethylene terephthalate, or multilayer polymeric constructions.

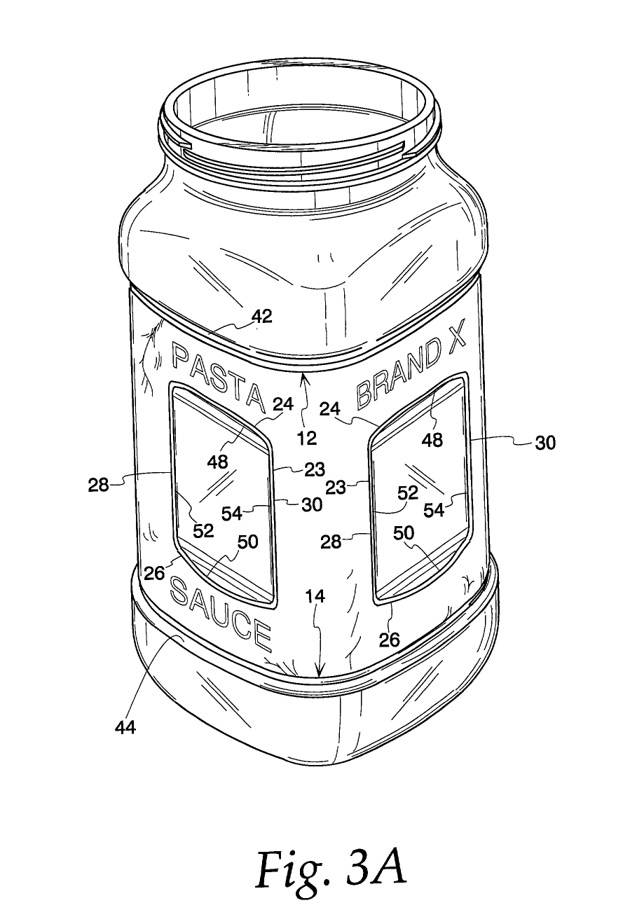

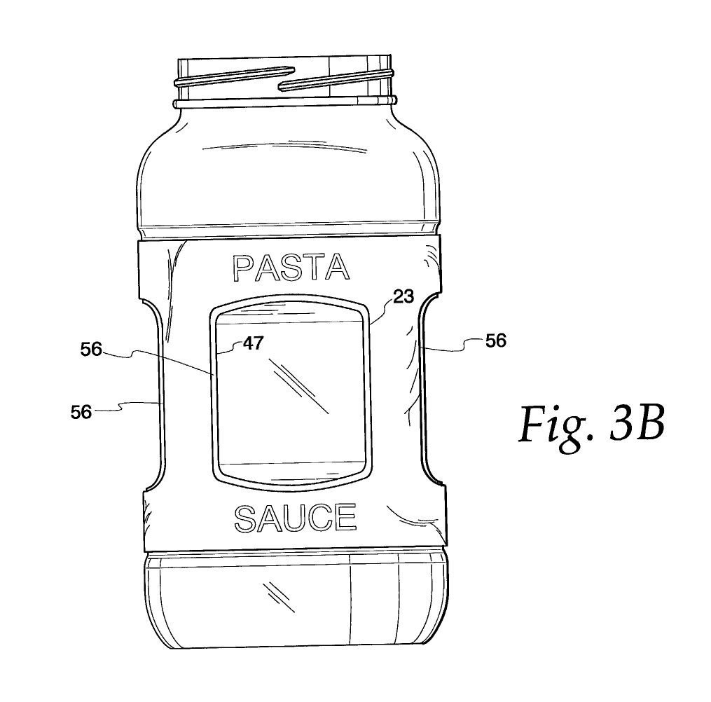

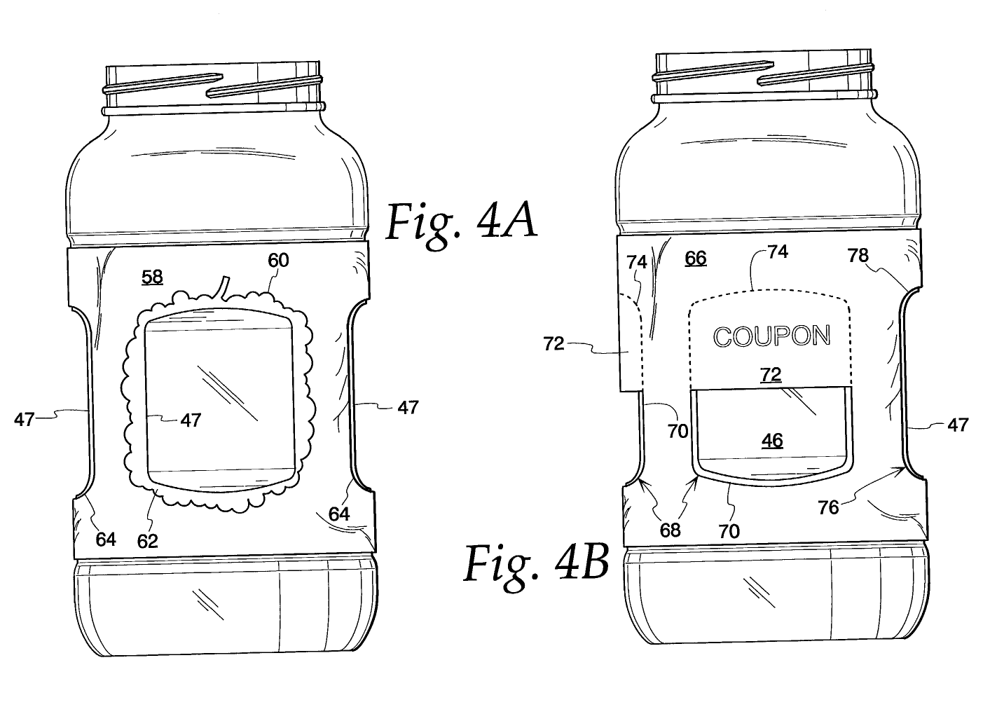

FIGS. 3A and 3B depict the container 32 of FIG. 2 adorned with the label 10 of FIG. 1. The label 10 is located on the container label panel 38 and, consistent with the present invention, each label window 22 is positioned to frame an associated container window 46. In other words, each label window perimeter 23 is positioned adjacent to an associated container window perimeter 47. The configuration of the label 10, as best seen in FIGS. 3A and 3B, comprises the label window perimeters 23 slightly larger than the container window perimeters 47 and of like configuration so that the label windows 22 frame the container windows 46 leaving a small gap 56 therebetween which exposes the container label panel 38. Alternatively, the label window perimeter 23 could be of identical size to, and run coextensive with, the container window perimeter 47 to eliminate the gap 56. The size of the gap 56 may vary without departing from the scope of the present invention. It is also within the scope of the present invention to vary the configuration of the label window perimeter from the configuration of the container window perimeter so that the gap therebetween will vary thereabout, as discussed in further detail below with regard to the alternate embodiments of the present invention depicted in FIGS. 4A and 4B. As with the embodiment depicted in FIG. 4B, the label window perimeter 23 may even encroach upon, and cover, portions of the container window perimeter 47. Moreover, although the embodiment of the label 10 depicted in FIGS. 1, 3A and 3B each comprise a number of windows 22 equal to the number of container windows 46, it is contemplated that the label 10 may have fewer windows 22 than the container 32 leaving some container windows 46 covered while exposing others. Furthermore, it is contemplated that the label 10 of the present invention may have more windows 22 than the container 32. For example, the depicted label 10 could be employed with a container comprising only two windows 46 so that the two container windows would be exposed and portions of the label panel 38 would be exposed on the sides of the container 32 not having one of the windows 46. This would allow for uniformity of labels, if, for example, the four window label 10 of FIG. 1 was a standard, while providing customers with more product visibility than if the non-windowed sides of the label panel 38 were completely covered.

The label 10 may applied to the container 32 by any method known to one of ordinary skill in the art. The gap 56 between the label window perimeter 23 and the container window perimeter 47 provides some room for error with regard to the registration of the label windows 22 with the container windows 46. Registration of the label windows 22 and the container windows 46 can be accomplished by any method known to one of ordinary skill in the art. It is also contemplated that registration may effectively be accomplished by employing a heat transfer label as the label 10 and applying the heat transfer label 10 to the container label panel 38 using a heat transfer or thermal label application method as are all well known to those of ordinary skill in the art. As is know to those of ordinary skill in the art, the heat transfer method will apply label only to the label panel 38 without applying any label into or over the recessed container windows 46. Alternatively, the invention could be accomplished by applying a windowless label to the container 32 and subsequently excising portions of the label to create the label windows 22.

FIG. 4A depicts the container 32 of FIG. 2 adorned with a label 58 of an alternative configuration. The label 58 comprises a first window perimeter 60 simulating the outer contour of a food item related to the product within the container 32. For example, the first label window perimeter 60 simulates the outer contour of a bunch of grapes and could be associated with a container 32 for holding a food product such as, by way of example only, grape jellies or jams. The first label window perimeter 60 need not match that of the associated container window perimeter 47. The first label window perimeter 60 exposes label panel 38 in a gap 62 between the first label window perimeter 60 and the container window perimeter 47. The label 58 also comprises three second label window perimeters 64 (only two depicted) framing the associated container window perimeters 47 in the manner of the label 10 depicted in FIGS. 1, 3A and 3B. The first label window perimeter 60 may be duplicated for any of the other label windows of the label 58.

FIG. 4B depicts the container 32 of FIG. 2 adorned with a label 66 of another alternative configuration. The label 66 comprises two first label windows 68 having a first window perimeter configuration 70. The window perimeter exposes only a portion of the container window 46 while covering the remainder of the window with an overlay portion 72 of the label 66. The depicted embodiment of label 66 provides each first window perimeter configuration 70 with a series of perforations 74 about the perimeter of the overlay 72 to facilitate easy removal thereof. The overlay could comprise, for example, a coupon or recipe suggestions. The label 66 further comprises two windows 76 (one depicted) having a second window perimeter 78 framing the associated container window perimeters 47 in the manner of label 10 depicted in FIGS. 1, 3A and 3B.

Combinations of the label window perimeters depicted in FIGS. 1-4B, as well as other label window perimeters not depicted, are contemplated.

The label 10 is constructed of any standard label material known to those of ordinary skill in the art. For example, the label 10 may be constructed of a paper or polymer film imprinted with the desired product and manufacturer information as well as other information dictated by government regulation.

From the foregoing description, it will be apparent that the present invention has a number of advantages, some of which have been described above and others of which are inherent in the present invention. Also, it will be understood that modifications can be made to the present invention without departing from the teachings of the invention. Accordingly the scope of the invention is only to be limited as necessitated by the accompanying claims.

I claim:

1. A container having a finish, a shoulder extending from the finish to an upper end of a label panel and a base closing a lower end of the label panel, the container further comprising:
a container window located in the label panel; and
a label defining a window in register with the container window.

2. The container of claim 1, the container window having a container window perimeter and the label window defining a label window perimeter associated with the container window perimeter.

3. The container of claim 2, the label window perimeter substantially framing the container window perimeter.

4. The container of claim 3, the label window perimeter exposing the container label panel in a gap between the label window perimeter and the container window perimeter.

5. The container of claim 4, the magnitude of the gap varying about the perimeter of the container window perimeter.

6. The container of claim 2, the label window perimeter being substantially coextensive with the container window perimeter.

7. The container of claim 2, the label window perimeter covering a portion of the container window perimeter.

8. The container of claim 1 comprising a second container window covered by the label.

9. A container having a finish, a shoulder extending from the finish to an upper end of a label panel and a base closing a lower end of the label panel, the container further comprising:
a container window having a container window perimeter, located in the label panel; and
a label comprising a window defining a label window perimeter, the label window perimeter associated with the container window perimeter.

10. The container of claim 9, the label window perimeter substantially framing the container window perimeter.

11. The container of claim 10, the label window perimeter exposing the container label panel in a gap between the label window perimeter and the container window perimeter.

12. The container of claim 11, the magnitude of the gap varying about the perimeter of the container window perimeter.

13. The container of claim 9, the label window perimeter being substantially coextensive with the container window perimeter.

14. The container of claim 9, the label window perimeter covering a portion of the container window perimeter.

15. The container of claim 9 comprising a second container window covered by the label.

16. A label for use with a container comprising a window having a container window perimeter, the label comprising:
a window defining a label window perimeter for association with the container window perimeter.

17. The label of claim 16, the label window perimeter configured to substantially frame the container window perimeter.

18. The label of claim 17, the label window perimeter configured to expose the container label panel in a gap between the label window perimeter and the container window perimeter.

19. The label of claim 18, the label window perimeter configured to vary the gap about the perimeter of the container window perimeter.

20. The label of claim 16, the label window perimeter configured to substantially coextend with the container window perimeter.

21. The label of claim 16, the label window perimeter configured to cover a portion of the container window perimeter.

22. The label of claim 16 configured to cover a second container window.
